(19) United States
(12) Patent Application Publication
(10) Pub. No.: US 2012/0259590 A1
(43) Pub. Date: Oct. 11, 2012

(54) METHOD AND APPARATUS FOR COMPRESSED SENSING WITH JOINT SPARSITY

(76) Inventors: Jong Chul YE, Daejeon (KR); Jong Min KIM, Daejeon (KR); Ok Kyun LEE, Daejeon (KR); Yoram BRESLER, Urbana, IL (US); Kiryung LEE, Urbana, IL (US)

(21) Appl. No.: 13/084,347

(22) Filed: Apr. 11, 2011

(51) Int. Cl. G06F 15/00

(52) U.S. Cl. 702/189

(57) ABSTRACT

Provided is a method and apparatus for support recovery of jointly sparse signals from a plurality of snapshots, thereby enhancing a capability for reconstructing a support in a variety of circumstances, by providing enhanced robustness against noise and perturbation, and/or enhanced computational efficiency. The method may include partial support recovery using a compressed sensing-multiple measurement vector (CS-MMV) scheme; and a complementary support recovery and sparsity level estimation. The complementary support recovery may use subspace information extracted from the plurality of snapshots and partial support information. The total number of elements in the partial support and in the complementary support may be equal to the sparsity level.

The present invention was made with support from the U.S. Government under grants No. CCF 06-35234 and No. CCF 10-18660 awarded by the National Science Foundation. The U.S. Government has certain rights in the present invention.

### BACKGROUND

1. Field of the Invention

The present invention relates to the processing of digital information, and more particularly, to compressed sensing and to a method and apparatus for allowing acceptable-quality reconstruction of a signal, an image, a spectrum, or other digital objects of interest from a plurality of measurement vectors when the signal corresponds to a plurality of jointly sparse vectors.

The present invention was made with support from the Korean Government under grant No. 2009-0081089 by the Korea Science and Engineering Foundation (KOSEF) and grants funded by the Korean government (MEST).

2. Description of the Related Art

In a wide range of signal and image sensing applications, there is a need to reconstruct a signal or to extract information about the signal using a reduced number of measurements.

When the number of measurements is smaller than a number of unknowns, the signal cannot be uniquely determined, unless additional information is available.

Compressed sensing aims to reconstruct a sparse vector from a measurement vector containing a small number of measurements that are related to the unknown sparse vector, through a linear transformation described by a so-called sensing matrix, by taking advantage of the sparsity constraint. The sparse vector may be a vector with only a fraction of components different from zero.

Owing to the sparsity constraint, even an underdetermined linear system may have a unique solution.

Compressed sensing is disclosed in the U.S. Patent Application, published on Feb. 9, 2006, entitled Method and Apparatus for Compressed Sensing, which is incorporated by reference for all purposes, and which provides a method for approximating a digital signal or an image using compressed sensing.

A related application is sparse coding, which computes a succinct representation or an approximation to a given vector by a linear combination of a small number of vectors from a collection of vectors known as a dictionary. The vectors in the dictionary are called atoms.

The problem of computing a sparse approximate solution to a linear system has also been studied as the subset selection problem in matrix computations with applications related to statistical regression and signal processing.

In these various situations, the identification of the support is of significant importance. The support may correspond to a set of indices of atoms that contribute to a sparse solution. The identification of the support is generally referred to as the sparse support recovery problem.

In some applications, there are multiple measurement vectors, also called snapshots. Each snapshot may correspond to a different unknown vector. The snapshots may have a special property wherein all unknown vectors share a common support.

The sparse recovery problem with respect to the aforementioned joint structure in the sparse solutions is generally referred to as a joint sparse recovery problem or a multiple measurement vector (MMV) problem. In many cases, the MMV problem may be easier to solve and may provide more accurate results than the sparse recovery problem with a single measurement vector (SMV).

In the mid 1990's, Bresler and Feng introduced the first compressed sampling scheme and theory, “spectrum-blind sampling” in their publications (P. Feng and Y. Bresler, Spectrum-blind minimum-rate sampling and reconstruction of multiband signals, Proc. ICASSP, 1996, and P. Feng, Universal minimum-rate sampling and spectrum-blind reconstruction for multiband signals, PhD thesis, University of Illinois at Urbana-Champaign, 1997).

The forgoing scheme enables sub-Nyquist minimum-rate sampling and perfect reconstruction of analog and discrete multiband signals in one or more dimensions, with unknown but sparse spectral support. The scheme allowed for a spectrum-blind reconstruction problem to be reduced to a finite-dimensional joint sparse recovery problem.

A joint sparse recovery formulation and methods for the recovery of sparse brain excitations was introduced in publications by Rao et al. (cf. (B. D. Rao and K. Kreutz-Delgado Sparse solutions to linear inverse problems with multiple measurement vectors, Proc. IEEE DSP Workshop, 1998), and references therein).

The problem of the estimation of direction of arrival (DOA) in sensor array processing was formulated as a joint sparse recovery problem by Malioutov et al. (D. Malioutov, M. Cetin, and A. Willsky, “A sparse signal reconstruction perspective for source localization with sensor arrays” IEEE Trans. Signal Process., vol. 53, no. 8, pp. 3010-3022, August 2005). They used the fact that for the typically small number of sources in this problem, the indicator function of the quantized angles of arrival can be modeled to be sparse.

Subsequently, the problem of variable selection in multivariate regression was formulated as a joint sparse recovery problem by Obozinski et al. (G. Obozinski, B. Taskar, and M. Jordan, “Joint covariate selection and joint subspace selection for multiple classification problems,” Statistics and Computing, vol. 20, no. 2, pp. 231-252, 2010). In their formulation the design matrix in regression corresponds to the linear system matrix in the joint sparse recovery problem and the set of indices of the variables that mostly contribute to the given data are assumed to be sparse.

To address the various application in which the joint sparse recovery problem arises, algorithms have been developed to exploit the structure in this problem

In theory, just as the SMV problem in compressed sensing, which corresponds to l₀ minimization, the problem of recovering jointly sparse signals may be generally non-deterministic polynomial-time (NP) hard.

In response, for the case where the nonzero rows in the unknown signal matrix have a full rank, Bresler and Feng proposed in their publications (P. Feng and Y. Bresler, Spectrum-blind minimum-rate sampling and reconstruction of multiband signals, Proc. ICASSP, 1996, P. Feng, Universal minimum-rate sampling and spectrum-blind reconstruction for multiband signals, PhD thesis, University of Illinois at Urbana-Champaign, 1997, Y. Bresler and P. Feng, Spectrum-blind minimum-rate sampling and reconstruction of 2-d multiband signals in Proc. ICIP) to use a version of the MUltiple SIgnal Classification (MUSIC) algorithm developed by Schmidt (refer to R. Schmidt, “Multiple emitter location and signal parameter estimation,” IEEE Trans. Antennas Propag., vol. 34, no. 3, pp. 276-280, 1986) for sensor array processing.

Bresler and Feng also proposed in the same publications mentioned earlier methods based on a greedy search or a greedy pursuit (a normalized version of orthogonal matching pursuit) inspired by the alternating projections algorithm from the publication (I. Ziskind and M. Wax, “Maximum likelihood localization of multiple sources by alternating projection,” IEEE Trans. Acoust., Speech, Signal Process., vol. 36, no. 10, pp. 1553-1560, 1988) in DOA estimation, which was later referred to as orthogonal least squares (OLS) in the publication (S. Chen, S. Billings, and W. Luo, “Orthogonal least squares methods and their application to non-linear system identification,” International Journal of Control, vol. 50, no. 5, pp. 1873-1896, 1989).

Variations of orthogonal matching pursuit (OMP) from a publication (Y. Pati, R. Rezaiifar, and P. Krishnaprasad, Orthogonal matching pursuit: recursive function approximation with applications to wavelet decomposition, in Proc. Asilomar Conf. on Signals, Systems, and Computers, 1993) have been proposed as efficient solutions for the joint sparse recovery, including MMV orthogonal matching pursuit (M-OMP) in publications (S. Cotter, B. Rao, K. Engan, and K. Kreutz-Delgado, “Sparse solutions to linear inverse problems with multiple measurement vectors,” IEEE Trans. Signal Process., vol. 53, no. 7, pp. 2477-2488, July 2005), simultaneous orthogonal matching pursuit (S-OMP) (J. Tropp, A. Gilbert, and M. Strauss, “Algorithms for simultaneous sparse approximation. Part I: Greedy pursuit,” Signal Processing, vol. 86, no. 3, pp. 572-588, 2006), and p-OMP (R. Gribonval, H. Rauhut, K. Schnass, and P. Vandergheynst, “Atoms of all channels, unite! Average case analysis of multi-channel sparse recovery using greedy algorithms,” Journal of Fourier analysis and Applications, vol. 14, no. 5, pp. 655-687, 2008).

One of the computationally simplest algorithms, the p-threshold algorithm, works by estimating the indices of the k columns of the sensing matrix that are most correlated to the measured snapshots to be an actual support set. (See R. R. Gribonval, H. Rauhut, K. Schnass, and P. Vandergheynst, “Atoms of all channels, unite! Average case analysis of multi-channel sparse recovery using greedy algorithms,” Journal of Fourier analysis and Applications, vol. 14, no. 5, pp. 655-687, 2008.)

Optimization schemes with convex relaxation of the l₀ norm to the l₁ norm such as basis pursuit (see S. Chen, D. Donoho, and M. Saunders, “Atomic decomposition by basis pursuit,” SIAM review, vol. 43, no. 1, pp. 129-159, 2001) and LASSO (see R. Tibshirani, “Regression shrinkage and selection via LASSO,” Journal of the Royal Statistical Society, Series B, pp. 267-288, 1996) have been successfully employed as reconstruction algorithms for compressed sensing for the SMV case and the idea has been also extended to the MMV case.

In particular, relaxation-based optimization formulations with diversity measures, known as mixed norm, have been studied (refer to D. Malioutov, M. Cetin, and A. Willsky, “A sparse signal reconstruction perspective for source localization with sensor arrays,” IEEE Trans. Signal Process., vol. 53, no. 8, pp. 3010-3022, August 2005, S. Cotter, B. Rao, K. Engan, and K. Kreutz-Delgado, “Sparse solutions to linear inverse problems with multiple measurement vectors,” IEEE Trans. Signal Process., vol. 53, no. 7, pp. 2477-2488, July 2005, J. Tropp, “Algorithms for simultaneous sparse approximation. Part II: Convex relaxation,” Signal Processing, vol. 86, no. 3, pp. 589-602, 2006, J. Chen and X. Huo, “Theoretical results on sparse representations of multiple-measurement vectors,” IEEE Trans. Signal Process., vol. 54, no. 12, pp. 4634-4643, December 2006 G. Obozinski, M. Wainwright, and M. Jordan, “Support union recovery in high-dimensional multivariate regression,” Annals of Statistics).

In the publication (D. Malioutov, M. Cetin, and A. Willsky, “A sparse signal reconstruction perspective for source localization with sensor arrays,” IEEE Trans. Signal Process., vol. 53, no. 8, pp. 3010-3022) the authors proposed an algorithm they called l₁-SVD and studied its empirical performance for joint sparse recovery in the context of source localization and DOA estimation.

In the publication (S. Cotter, B. Rao, K. Engan, and K. Kreutz-Delgado, “Sparse solutions to linear inverse problems with multiple measurement vectors,” IEEE Trans. Signal Process., vol. 53, no. 7, pp. 2477-2488, July 2005) the authors proposed an algorithm called MMV-Focal Underdetermined System Solution (MMV-FOCUSS) that works by minimizing a non-convex diversity measure, and showed it to converge to a local minimum of the cost function.

U.S. Pat. No. 7,511,643 to Barniuk et al, issued Mar. 31, 2009, entitled Method and apparatus for distributed compressed sensing discloses methods for processing a plurality of measurements, or snapshots, of jointly sparse signals when snapshots are obtained from different sensors with different sensing matrices.

For any method, apart from the quality of the performance guarantee that is available for it, empirical performance and computational cost are of key importance.

Empirically, the optimization schemes with diversity measures often perform better than greedy algorithms. However, both classes of approaches have weaknesses.

In particular, the success rate of joint sparse recovery may not improve as the rank of the unknown jointly sparse signal matrix increases beyond a certain level.

Similarly, under unfavorable settings such as rank deficiency or ill conditioning of the unknown jointly sparse signal matrix, existing algorithms for the joint sparse recovery, while not failing, may be far from achieving the theoretical algebraic boundary on the joint sparsity level that can be recovered, which has been established by Chen and Huo (J. Chen and X. Huo, “Theoretical results on sparse representations of multiple-measurement vectors,” IEEE Trans. Signal Process., vol. 54, no. 12, pp. 4634-4643, December 2006).

While the optimization schemes empirically perform better than the greedy algorithms, this improved performance may come at a much higher computational cost.

For convex diversity measures such as those employed in l₁-SVD and Group LASSO, the optimization may be cast as second order cone programming (SOCP) according to the publication (D. Malioutov, M. Cetin, and A. Willsky, “A sparse signal reconstruction perspective for source localization with sensor arrays,” IEEE Trans. Signal Process., vol. 53, no. 8, pp. 3010-3022, August 2005).

However, both the second order and the first order iterative algorithms for SOCP suffer from poor scalability and slow convergence rates, respectively. In contrast, the number of the steps for greedy algorithms and MUSIC are a finite number that depends on the sparsity level, making these algorithms computationally attractive.

In view of various drawbacks of the existing algorithms for the joint sparse recovery, the MUSIC algorithm, when it works, is extremely attractive. In a favorable setting where the matrix composed of the nonzero rows of the unknown jointly sparse signal vectors has full rank, MUSIC is guaranteed to recover the row-support and hence achieves the algebraic bound. Moreover, MUSIC is highly efficient computationally.

However, the full rank condition is often violated in practice. For example, if the number of snapshots N is smaller than the sparsity level k, no more than N rows can be linearly independent and the nonzero rows will be rank deficient. In other applications, such as spectrum-blind sampling or the DOA problem, N may be large or even infinite. Even in this case, the rank might be smaller than k, or the condition number of the sub-matrix composed of the nonzero rows may be very large. This latter situation may arise due to coherence between sources or due to multipath propagation.

It is well known that MUSIC fails in this practically important rank-deficient case and this has motivated numerous attempts to overcome this problem, without resorting to infeasible multi-dimensional search.

However, all these previous methods use special structure of the linear system such as shift invariance that enables to apply so-called spatial smoothing as described by T.-J. Shan et al (T.-J. Shan, M. Wax, and T. Kailath, “On spatial smoothing for direction-of-arrival estimation of coherent signals,” IEEE Trans. Acoust., Speech, Signal Process., vol. 33, no. 4, pp. 806-811, 1985).

Accordingly, previous extensions of MUSIC may not be applicable to the general joint sparse recovery problem.

In summary, the MUSIC algorithm may be used for reconstruction only when the rank of the jointly sparse signal matrix is sufficiently high, while the above greedy or optimization-based algorithms, to which we collectively refer as the compressed sensing-MMV (CS-MMV) algorithm, may be employed for reconstruction regardless of the rank of the signal matrix.

However, the sparsity level that can be recovered by the CS-MMV algorithm does not approach the value theoretically predicted by the algebraic 10 bound, especially when the rank of the jointly sparse signal matrix is high.

Furthermore, although the optimization-based methods perform better in this respect than the greedy algorithms, their computational cost is much higher.

For brevity and for consistency with the terminology used in the sensor array processing literature, the sparsity level of a signal, or the number of nonzero components, equivalently the number of elements in the support of a sparse signal, will be referred to as the number of targets.

### SUMMARY

An aspect of the present invention provides a method and apparatus for support recovery of jointly sparse signals from a plurality of snapshots.

An aspect of the present invention also provides a method and apparatus for performing a partial support recovery and a complementary support recovery using a compressed sensing-multiple measurement vector (CS-MMV) scheme.

According to an aspect of the present invention, there is provided a method of extracting information from a plurality of measurement vectors of jointly sparse signals, the method including: extracting signal subspace information from the plurality of measurement vectors of the jointly sparse signals; computing a subset with at least one element of a joint support based on the plurality of measurement vectors; and computing at least one additional element of the joint support based on the signal subspace information and the subset.

The plurality of measurement vectors may be obtained from at least one sensor.

The signal subspace information may include at least one of the dimension of a signal subspace, a basis for spanning the signal subspace, a projection onto the signal subspace, a basis for the orthogonal complement of the signal subspace, and a projection onto the orthogonal complement of the signal subspace.

The extracting of the signal subspace information may be performed by a singular value decomposition (SVD) , principal component analysis (PCA), or robust PCA.

The computing of the subset may use the signal subspace information.

The computing of the subset may include partially executing a greedy CS-MMV algorithm for support recovery.

The computing of the subset may include obtaining a subset of the joint support according to a support recovery scheme.

The computing of the subset may be performed by thresholding a measure of the magnitudes of signal estimates obtained according to a jointly sparse signal recovery scheme.

The computing of the subset may be repeated to generate a plurality of candidate subsets of the joint support.

The computing of the at least one additional element may use an augmented signal subspace, formed by augmentation of the signal subspace estimate by the subspace spanned by columns of the sensing matrix that are indexed by the subset of the joint support.

The computing of the at least one additional element may include finding, from the columns of the sensing matrix whose indices are absent in the subset of the joint support, at least one column whose orthogonal projection onto the augmented signal subspace has largest Euclidean norm.

The computing of the at least one additional element may include finding, from the columns of the sensing matrix whose indices are absent in the subset of the joint support, at least one column whose orthogonal projection onto the orthogonal complement of the augmented signal subspace has smallest Euclidean norm.

The method may further include estimating a sparsity level of a jointly sparse signal according to a greedy support recovery algorithm.

According to another aspect of the present invention, there is provided a method of processing a plurality of snapshots, the method including: receiving the plurality of snapshots; generating first supports of a solution matrix according to a CS-MMV scheme selected using the plurality of snapshots; and generating second supports of the solution matrix according to a subspace based scheme using the plurality of snapshots and the first supports.

The method may further include estimating a number of targets. The total number of elements in the first subset and in the second support may correspond to the number of targets.

The generating of the second subset, that is of the complementary support, may include using the rank of a matrix generated using the plurality of snapshots, and a basis vector of a dictionary not included in the first subset.

According to still another aspect of the present invention, there is provided an apparatus for a support recovery of jointly sparse signals from a plurality of snapshots, the apparatus including: a receiving unit to receive the plurality of snapshots; and a controller to generate a first subset of an estimate of the joint support of according to a CS-MMV scheme using the plurality of snapshots, and to generate a second subset of an estimate of the joint support according to a subspace based scheme using the plurality of snapshots and the first subset.

The controller may estimate a number of targets. The total number of elements in the first subset and in the second subset may correspond to the number of targets.

The controller may generate the second subset based on the rank of a matrix generated using the plurality of snapshots, the first subset, and a basis vector of a dictionary, wherein the index of the basis vector is excluded from the first subset.

According to yet another aspect of the present invention, there is provided a method of processing a plurality of snapshots of jointly sparse signals, the method including: receiving the plurality of snapshots; generating a first matrix including the plurality of snapshots; generating a first subset of an estimate of the joint support of jointly sparse signals according to a CS-MMV scheme, the CS-MMV scheme using the first matrix, wherein the number of elements in the first subset is determined based on the difference between the number of estimated targets and the rank of the first matrix; and generating a second subset of the estimated joint support of the jointly sparse signals based on the matrix and the first subset.

The method may further include generating an estimate of an unknown sparsity level based on a cost function. An output value of the cost function may correspond to a minimum value within a predetermined range.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a process of obtaining measurements of jointly sparse signals using sensors according to an embodiment of the present invention;

FIG. 2 is a diagram illustrating a linear model for generating measurement vectors or snapshots from jointly sparse signal vectors according to an embodiment of the present invention;

FIG. 3 is a block diagram illustrating a process of reconstructing signals from measurements according to an embodiment of the present invention;

FIG. 4 is a block diagram illustrating a detailed configuration of the first block of FIG. 2.

FIGS. 5A and 5B are graphs showing examples of the performance of Subspace-Augmented MUltiple SIgnal Classification (SA-MUSIC) according to an embodiment of the present invention, compared to other known methods;

FIGS. 6A and 6B are graphs showing other examples of the performance of a SA-MUSIC according to an embodiment of the present invention, compared to other known methods;

FIGS. 7A and 7B are graphs showing examples of the performance of compressed sensing (CS)-MUSIC according to an embodiment of the present invention, compared to other known methods;

FIGS. 8A and 8B are graphs showing examples of a cost function for a sparsity estimation operation according to an embodiment of the present invention; and

FIG. 9 is a block diagram illustrating a structure of an apparatus for processing a plurality of measurements or snapshots of jointly sparse signals, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Real-valued signals and matrices may be used as an example. However, embodiments of the present invention may be equally applicable to complex-valued signals and matrices simply by replacing real numbers [symbol] by complex numbers [symbol] , and by replacing transpose T by Hermitian transpose H.

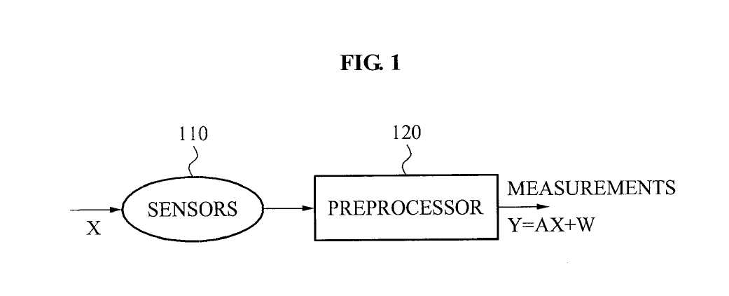

FIG. 1 is a diagram illustrating a process of obtaining measurements of jointly sparse signals using sensors 110 according to an embodiment of the present invention.

Specifically, FIG. 1 shows an example of a sensing system obtaining a plurality of measurements of jointly sparse signals.

Unknown jointly k-sparse signals may be arranged as columns of a matrix X ∈ [symbol] ^{n×N}.

The sensors 110 may acquire initial measurements of the unknown jointly k-sparse signals. Specifically, measurements may be obtained from at least one sensor.

Snapshots may denote linear measurements of the jointly sparse signals, and may be arranged as columns of matrix Y ∈ [symbol] ^{m×N}.

A preprocessor 120 may preprocess the initial measurements of the unknown jointly k-sparse signals and thereby generate the linear measurements of the jointly sparse signals.

After possible preprocessing, the snapshots may be associated with the unknown jointly k-sparse signals by the following model of Equation 1:

Y=AX+W [Equation 1]

Where A=[a₁, . . . , aₙ]∈ [symbol] ^{m×n} denotes a known sensing matrix and W ∈ [symbol] ^{m×N} denotes an unknown perturbation.

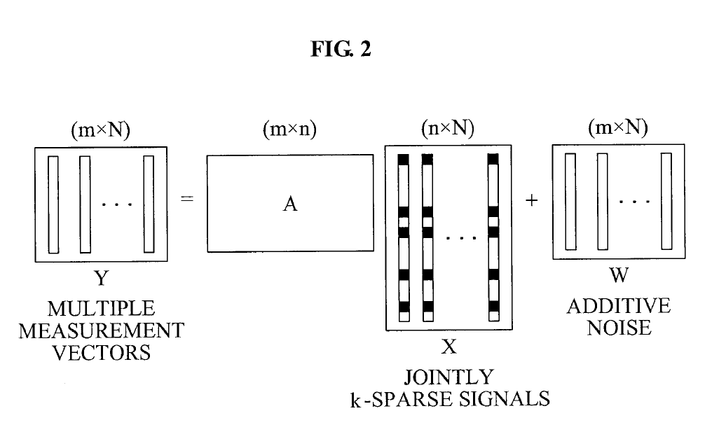

The model of Equation 1 will be further described with reference to FIG. 2.

The support of a vector x ∈ [symbol] ⁿ corresponds to the set of indices of nonzero components of x.

Similarly, the joint support of matrix X corresponds to the set of indices of nonzero rows of X.

When the columns of X have different supports, the joint support denotes the union of supports of all the columns.

The present invention may also be applicable to the case where signals are jointly sparse over a certain dictionary or a basis D ∈ [symbol] ^{n×d}. That is, X=DZ where Z ∈ [symbol] ^{d×N} is jointly k-sparse.

In this case, by considering a composition AD as a sensing matrix replacing A in Equation 1 and by considering Z as unknown sparse vectors replacing X, the linear system that arises in support recovery may be reduced to Equation 1.

Here, whether signals are sparse or have a sparse representation over a dictionary or a basis may not become an issue.

A goal of jointly sparse support recovery is to estimate the joint support of X. This may be an ultimate goal in applications such as direction of arrival (DOA) estimation in sensor array processing according to a publication (D. Malioutov, M. Cetin, and A. Willsky, “A sparse signal reconstruction perspective for source localization with sensor arrays,” IEEE Trans. Signal Process., vol. 53, no. 8, pp. 3010-3022, August 2005).

In applications in which it is desired to obtain an estimate of X itself, once the support is estimated, the reconstruction of matrix Ψ, containing nonzero rows of X, may be formulated as a conventional least squares problem min_{Ψ}∥Y−A_{Ĵ}Ψ∥_{F}² with a submatrix A_{Ĵ}=[aⱼ_{₁}, . . . , aⱼ_{ₖ}]. Here, Ĵ={j₁, . . . , jₖ} denotes the estimated support.

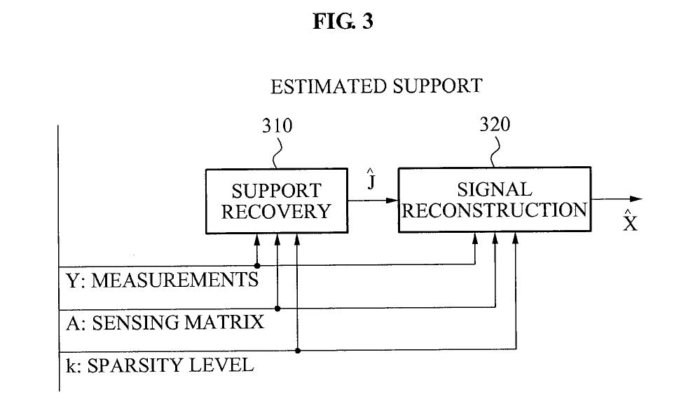

Solving this problem may employ one of known efficient numerical methods for linear least-squares problems. A two-step procedure for the estimation of X is illustrated in FIG. 3.

FIG. 3 is a block diagram illustrating a process of reconstructing signals from measurements according to an embodiment of the present invention.

In operation 310, support information may be recovered from measurements. In operation 320, a signal may be reconstructed based on the support information.

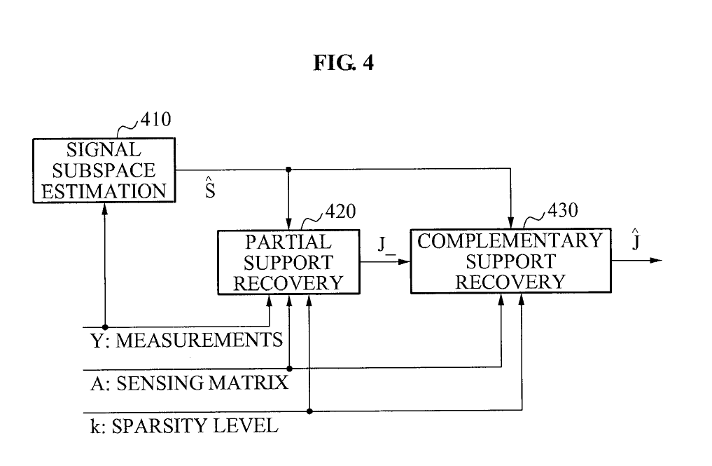

FIG. 4 is a block diagram illustrating a detailed configuration of a first block, that is, operation 310 of FIG. 3.

The support recovery may be performed by two operations: a partial support recovery and a complementary support recovery.

Both operations may employ estimated information of a signal subspace spanned by measurement vectors. In particular, when the partial support recovery successfully provides a subset of support of a size specified based on the subspace information, the complementary support recovery may be reduced to an easier problem.

Initially, presented is a family of embodiments, each including the following three operations: operation 410 of signal subspace estimation; operation 420 of partial support recovery; and operation 430 of complementary support recovery.

Hereinafter, each of operation 410, 420, and 430 will be further described with one or more exemplary implementations. The embodiments may be any combination of the implementations for each of the operations 410, 420, and 430.

Signal Subspace Estimation

A signal subspace corresponds to a subspace of [symbol] ⁿ that is spanned by columns of AX.

Signal subspace information may include at least one of a dimension of a signal subspace, a basis for spanning the signal subspace, a projection onto the signal subspace, a basis for an orthogonal complement of the signal subspace, and a projection onto the orthogonal complement of the signal subspace.

In operation 410 of FIG. 4, the signal subspace information may be extracted from a plurality of measurements of jointly sparse signals.

In operation 410, the following arguments may be received:

1) Sparsity level k: denotes the size of a support to be estimated

2) Sensing matrix A: describes how linear measurements Y are related to unknown signals X.

3) Matrix Y of snapshots

Here, the parameter k may be either pre-specified or estimated from Y. The estimation of parameter k from Y will be described later.

When k is given, the dimension r of the signal subspace may be constrained by r≦k.

In operation 410, snapshots may be received. A matrix may be generated based on the received snapshots.

For example, one way (as taught by Schmidt, IEEE Trans. Antennas Propag., vol. 34, no. 3, pp. 276-280, 1986) to compute an estimate of the signal subspace is to use principal component analysis (PCA) (Jolliffe, Principal component analysis, Springer-Verlag, 1986) or a singular value decomposition (SVD) of matrix Y.

Specifically, the estimation of signal subspace information may be performed by the SVD or the PCA.

The dimension r may be determined based on the number of largest singular values of Y that dominate the other singular values. For a special case where the perturbation is assumed to be white noise with covariance equal to a scaled identity matrix, the dimension r may be alternatively determined based on the size of the set of singular values, excluding a set of least singular values of similar magnitudes.

A similar approach may be used with pre-whitening or the Mahalanobis transformation, by a multiplication of matrix Y by an inverse square root of the noise covariance when a covariance matrix of noise W is known or estimated up to a scaling factor, or by employing a generalized eigenvalue decomposition in a PCA procedure instead of a regular eigenvalue decomposition.

Once the dimension r is specified, an estimate Ŝ of the signal subspace S may be obtained from the r dominant left singular vectors of Y.

The estimate Ŝ may be represented by one of the following:

1) Orthonormal basis Φ_{Ŝ} for Ŝ

2) Orthonormal basis for Ŝ^{⊥}, which is a subspace perpendicular to Ŝ

3) Projection onto Ŝ

4) Projection onto Ŝ⁻.

All of 1) through 4) may be determined from a truncated SVD of Y.

For example, Φ_{Ŝ} may be given by the r dominant left singular vectors of Y.

The computation of the truncated SVD, equivalently rank-revealing eigenvalue decomposition, may be performed by efficient numerical algorithms such as the Lanczos method.

Also, randomized algorithms (of publication Rokhlin, Szlam, and Tygert, SIAM. J. Matrix Anal. & Appl. 31, pp. 1100-1124, 2009) may be used.

If W contains sparse and strong noise occurring due to the existence of outliers or strong impulsive noise, robust principal component analysis algorithms (refer to J. Wright, A. Ganesh, S. Rao and Y. Ma, Robust Principal Component Analysis: Exact Recovery of Corrupted Low-Rank Matrices by Convex Optimization, Neural Information Processing Systems (NIPS), 2009) that decompose a matrix into a low-rank approximation and a sparse error will provide a better estimate of the signal subspace.

Specifically, the estimation of signal subspace information may be performed by a robust PCA.

Partial Support Recovery

In operation 420, the following arguments may be received:

1) Sparsity level k

2) Signal subspace estimate Ŝ

3) Its dimension r

4) Sensing matrix A

A goal of operation 420 is to provide a partial support of size t where t≧k−r.

According to an exemplary embodiment of the present invention, t=k−r may be included to reduce the amount of computation and, in some cases, to improve overall recovery performance.

One of known greedy algorithms, for example, M-orthogonal matching pursuit (OMP), S-OMP, Subspace-OMP, and OMP for support recovery, may be employed in operation 420.

First t iterations of a greedy algorithm will provide a desired partial support.

An advantage of these algorithms is their low computational complexity. To improve the performance of the greedy algorithms, preconditioning (refer to K. Schnass and P. Vandergheynst, “Dictionary preconditioning for greedy algorithms,” IEEE Transactions on Signal Processing, Vol. 56, No. 5, pp. 1994-2002, 2008) of the sensing matrix may be applied.

Operation 420 may include partially executing a greedy algorithm for the support recovery.

Also, p-thresholding algorithms may be used for operation 420.

For better performance with higher computational complexity, sophisticated jointly sparse signal recovery algorithms followed by thresholding on a function (that is, a measure) of the magnitudes of the recovered signal may be employed.

Operation 420 may be performed by thresholding a measure of the magnitudes of signal estimates obtained according to a jointly sparse signal recovery scheme.

For example, multiple measurement vector (MMV) Basis Pursuit that is convex optimization method for minimizing the diversity given by a mixed norm of matrix, Group LASSO, or a belief propagation method may be incorporated.

A pseudo code for implementation of operation 420 with subspace-OMP (refer to K. Lee and Y. Bresler, Subspace-augmented MUSIC for joint sparse recovery with any rank, IEEE Sensor Array and Multichannel Signal Processing Workshop (SAM), 2010) may be expressed as Equation 2:

J₁←ø While |J₁|<t do j*←arg max_{j∈{1, . . . , n}\J}_{₁}∥Φ_{Ŝ}^{T}P_{R(A}_{_{J1}}₎_{^{⊥}}aₖ∥₂ J₁←J₁∪{j*} end while [Equation 2]

where J₁ is initialized as an empty set. In each iteration of the above algorithm, J₁ may increase by one additional element that maximizes a cost function until the size of J₁ reaches t.

As described above, in operation 420, a subset of the joint support may be obtained according to a support recovery scheme.

In operation 420, first subset of the estimate of the joint support of the jointly sparse signals X may be generated according to a compressed sensing (CS)-MMV scheme using received snapshots. This first subset corresponds to partial support subset J1. Here, the CS-MMV scheme may use a matrix generated using the snapshots and a cardinality t for J1 that is determined based on the difference k−r between the estimated number of targets k and the rank r of the matrix generated using the snapshots.

Complementary Support Recovery

In operation 430, at least one additional element of the joint support may be computed based on signal subspace information and partial support subset J1.

The computed at least one additional element may be referred to as second subset of an estimate of the joint support, or complementary support.

In operation 430, the second subset may be generated according to a subspace based scheme using snapshots or the matrix generated using the snapshots, and the first partial support subset generated in operation 420.

The procedure described here may be referred to as Subspace-Augmented MUSIC (SA-MUSIC) (refer to K. Lee and Y. Bresler, Subspace-augmented MUSIC for joint sparse recovery with any rank, IEEE Sensor Array and Multichannel Signal Processing Workshop (SAM), 2010).

When the estimated subspace Ŝ, the partial support J₁ of the size t, and sparsity level k are given, SA-MUSIC may compute a k-dimensional subspace estimate \tilde{S}, which is the augmentation of Ŝ by the subspace spanned by the columns of A indexed by J₁.

More specifically, \tilde{S} may correspond to the range space of concatenated matrix [A_{J}_{₁};Φ_{Ŝ}] where A_{J}_{₁}=[aⱼ_{₁}, . . . , aⱼ_{₁}] denotes the submatrix with the columns of A indexed by J₁={j₁, . . . , jₜ}.

Computation of an orthonormal basis for \tilde{S} may be performed according to known numerical algorithms such as the Gram-Schmidt method or QR factorization.

If matrix X or its left singular vectors are in general position, that is, every square submatrix with nonzero rows has a full rank, the dimension of \tilde{S} will be k, which is the full rank case.

When subspace \tilde{S} is given, the final operation of SA-MUSIC will be similar to MUSIC.

SA-MUSIC finds k columns of A that when projected onto \tilde{S} have largest length in Euclidean norm. Indeed, the columns indexed by J₁ are trivially included in the selection.

Accordingly, it may suffice to search over the indices outside J₁ to find k−t additional components.

A pseudo code summarizing the procedure described above may be expressed according to Equation 3:

Φ_{\tilde{S}}QR([Φ_{Ŝ};A_{J}_{₁}]) (QR factorization) for k ∈ {1, . . . , n}\J₁ do zⱼ←∥Φ_{\tilde{S}}^{T}aₖ∥₂ end for Ĵ←J₁∪{indices of the (k−t) largest zⱼ's} [Equation 3]

An equivalent procedure may also be given in terms of the projection operators onto the subspaces Ŝ and \tilde{S} instead of the bases for these subspaces.

As described above, operation 430 may use an augmented signal subspace formed by augmentation of a signal subspace estimate by the subspace spanned by columns of the sensing matrix. The columns may be indexed by the first subset of the joint support.

Also, operation 430 may include finding, from the columns of the sensing matrix whose indices are absent in the first subset of the joint support, at least one column whose orthogonal projection onto the augmented signal subspace has a largest Euclidean norm.

Alternatively, operation 430 may include finding, from the columns of the sensing matrix whose indices are absent in the first subset of the joint support, at least one column whose orthogonal projection onto the orthogonal complement of the augmented signal subspace has a smallest Euclidean norm.

Each of the aforementioned operations 410, 420, and 430 may use an estimate of parameter k.

To estimate k from snapshots Y, for example, any incremental greedy algorithm applied to Y for sparse signal reconstruction with a stopping criterion defined by a data fitting residual (refer to J. A. Tropp, “Average-case analysis of greedy pursuit,” In. Proc. SPIE Wavelets XI, pp. 590401.01-11, San Diego, August 2005) may provide a valid upper bound on k.

Another method for the estimation of k will be described later in the context of another embodiment of the present invention.

In yet another exemplary embodiment, operation 420 of the partial support recovery may be repeated to generate a plurality of candidate subsets for partial support. Operation 430 of the subsequent complementary support recovery may be repeated for each candidate partial support generating a set of candidate solutions Ĵ^{(l)}, l=1 . . . , L for the complete support.

The best of these may be selected as one minimizing a cost function according to Equation 4:

Cₗ=min_{Ψ}∥Y−A_{{Ĵ}_{^{(l)}}_{}}Ψ∥_{F}² [Equation 4]

Specifically, an unknown sparsity level may be generated based on the cost function. An output value of the cost function may correspond to a minimum value of an initial region of input values within a predetermined range.

Another Embodiment of Complementary Support Recovery

Hereinafter, another embodiment of operation 430 will be described.

Let Φ_{Ŝ} be given by the r dominant left singular vectors of Y. Next, using standard numerical linear algebra methods, for example, the Gram-Schmidt procedure, it is possible to obtain an orthogonal basis Q for the noise subspace defined as the orthogonal complement of signal subspace Ŝ.

Specifically, the following Equation 5 may be established:

R(Q)=Ŝ^{⊥}=R(Ψ_{Ŝ})^{⊥} [Equation 5]

Next, denoting the row support of X by J, another form of an embodiment called “compressive MUSIC” from a publication (J. M. Kim, O. K. Lee, and J. C. Ye, Multiple measurement vector problem with subspace-based algorithm, In. Proc. SIAM Conference on Imaging Science., Apr. 12-14, 2010) may be given according to Equation 6:

$$rank ( {Q}^{H} [ {A}_{{J}_{1}} ; {a}_{j} ] ) = \{ \begin{matrix}k - r , & j ∈ J \\ k - r + 1 , & otherwise\end{matrix} \qquad [ Equation 6 ]$$

Equation 6 may be combined with the definitions in Equation 7:

ξⱼ=gⱼ^{H}P_{G}_{_{J1}}^{⊥}gⱼ, [Equation 7]

where gⱼ=Q^{H}aⱼ, G_{J}_{₁}=Q^{H}A_{J}_{₁}, and P_{G}_{_{J1}}^{⊥} is the orthogonal projection onto the orthogonal complement of the range space of G_{J}_{₁}.

The condition described by Equation 6 may be equivalently represented by Equation 8:

ξⱼ=0, j ∈J [Equation 8]

For noisy measurements, the support estimate may be given by set of indices that give the k-smallest values for ξⱼ.

Specifically, the second subset, that is the complementary support estimate, may be generated based on an estimate of the dimension of the signal subspace obtained as the rank of a matrix generated using the plurality of snapshots and based on a basis vector of a dictionary excluded from the first subset, that is, from the partial support estimate.

Sparsity Level Estimation

In the above embodiments, the sparsity level k may be assumed to be known. If the sparsity level k is unknown, an estimate \hat{k} of k may be computed as follows.

Estimation of the sparsity level corresponds to estimating the number of targets.

Accordingly, the total number of elements in the first subset and in the second subset may correspond to the number of targets.

An operation of estimating the sparsity level k by means of a greedy support reconstruction algorithm may be added to the present embodiment.

Initially, an upper bound of sparsity may be defined as kmax. Then, for t=r+1, . . . , kmax, C(t) may be computed according to Equation 9.

$$C ( t ) = {min}_{{I ⋂ {J}_{1} ( t ) = Ø}_{\vert I \vert = r}} {\sum }_{j ∈ I} {g}_{j}^{H} {P}_{{G}_{{J}_{1} ( t )}}^{⊥} {g}_{j} \qquad [ Equation 9 ]$$

Where J₁(t) denotes a partial support of size t−r estimated by any MMV compressive sensing algorithm.

The estimate \hat{k} may be selected as a first local minimizer of C(t) with respect to t.

The minimization in Equation 9 may be over all index sets I of size r that include elements from {1, . . . , n} and no elements from J₁(t). For fixed t and J₁(t), this minimization may be performed by initially computing summands for all j ∈ {1, . . . , n}\J₁(t), and then selecting the r summand of smallest magnitude.

The value kmax may be a desired value provided as a parameter based on various practical considerations or based on theoretical considerations, such as theoretical bounds on the maximum sparsity level that may be recovered with a given sensing matrix and given rank r (see, for example, J. Chen and X. Huo, “Theoretical results on sparse representations of multiple-measurement vectors,” IEEE Trans. Signal Process., vol. 54, no. 12, pp. 4634-4643, December 2006).

Yet another way to determine kmax is by applying, to the snapshots Y, a greedy algorithm for MMV sparse signal reconstruction with stopping criterion defined by the data fitting residual, which is described above.

Through operations 410 through 430, information may be extracted from a plurality of measurement vectors of jointly sparse signals. Operations 410 through 430 may be considered as a method of processing a plurality of snapshots.

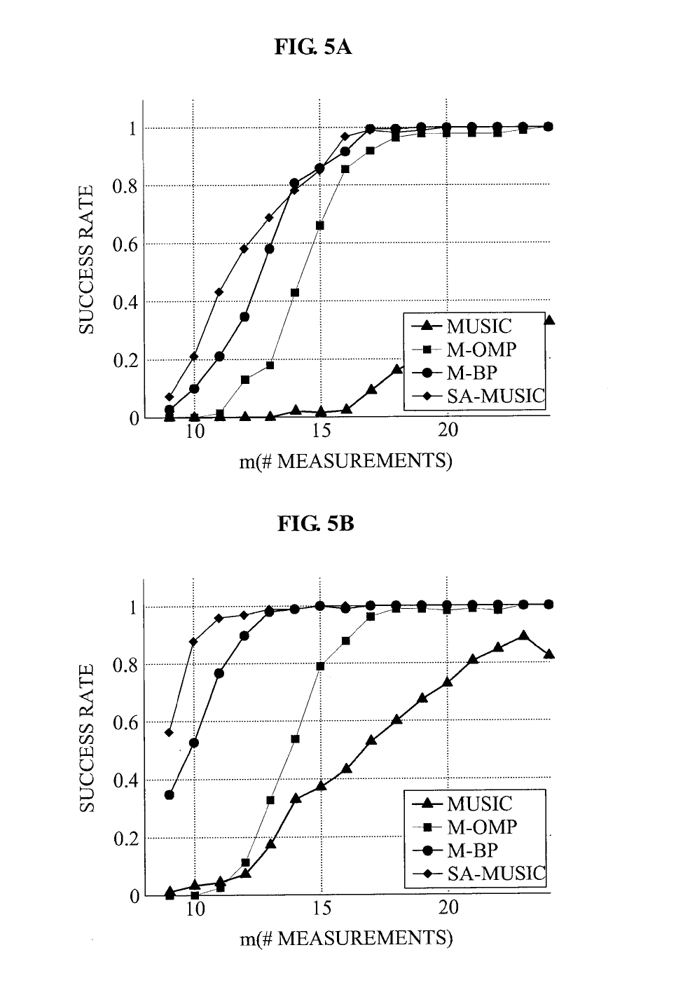

FIGS. 5A and 5B are graphs showing examples of the performance of SA-MUSIC according to an embodiment of the present invention compared to other known methods.

In particular, the performance under the rank deficiency of jointly sparse signals is shown.

Here, a sparsity level is 8 and the signal length is 128. In the graph of FIG. 5A, the rank is 4. In the graph of FIG. 5B, the rank is 6.

The SA-MUSIC algorithm may have a relatively low computational complexity and an enhanced performance compared to CS-MMV algorithms, for example, MMV Basis Pursuit and M-BP.

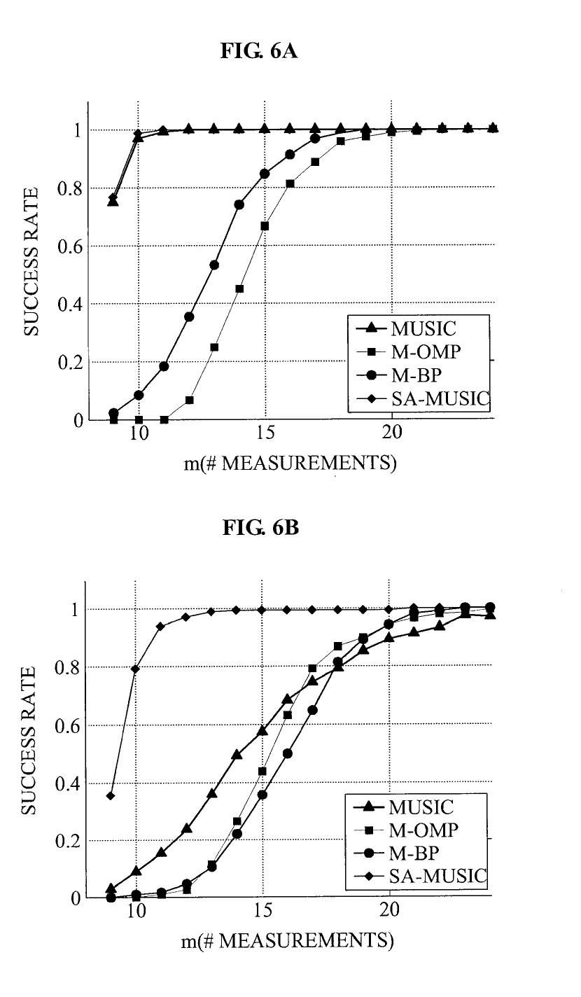

FIGS. 6A and 6B are graphs showing other examples of the performance of SA-MUSIC according to an embodiment of the present invention compared to other known methods.

In particular, the performance under ill-conditioning of jointly sparse signals is shown.

Here, the sparsity level is 8 and the signal length is 128. The rank is 8, however, the condition number is large.

For example, in the graph of FIG. 6A, the condition number is 10. In the graph of FIG. 6B, the condition number is 50.

The SA-MUSIC algorithm may have a relatively enhanced performance under the above unfavorable environment while the other methods suffer from this defect.

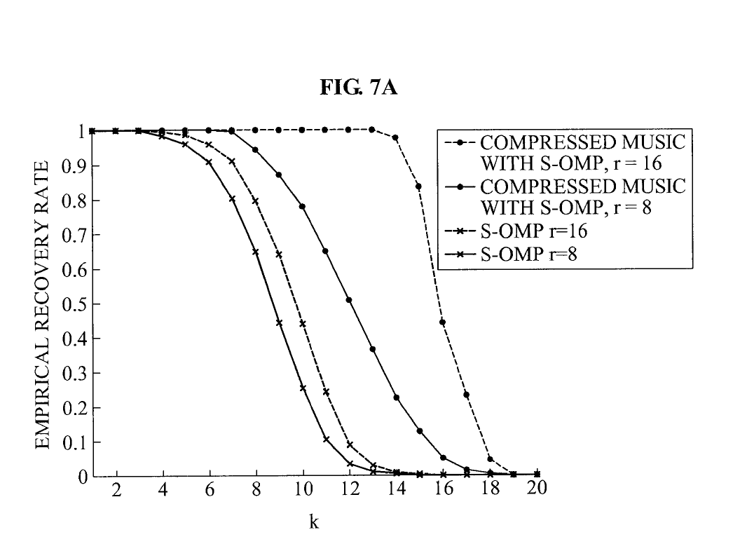

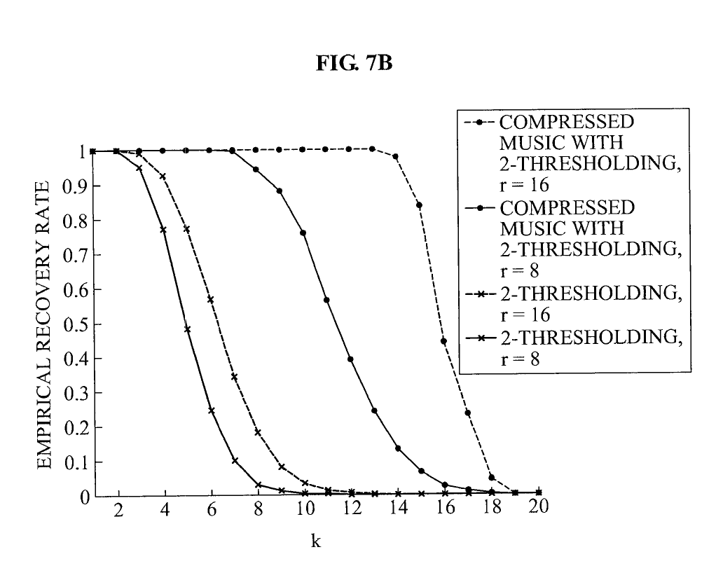

FIGS. 7A and 7B are graphs showing examples of the performance of CS-MUSIC according to an embodiment of the present invention compared to other known methods.

Here, the signal length is 20, the rank is 8, and the signal to noise ratio (SNR) is 30 dB.

CS-MUSIC may outperform S-OMP as shown in the graph of FIG. 7A, or may outperform 2-thresholding as shown in the graph of FIG. 7B when only partial supports are found by S-OMP and 2-thresholding and the complementary supports are found by the MUSIC criterion.

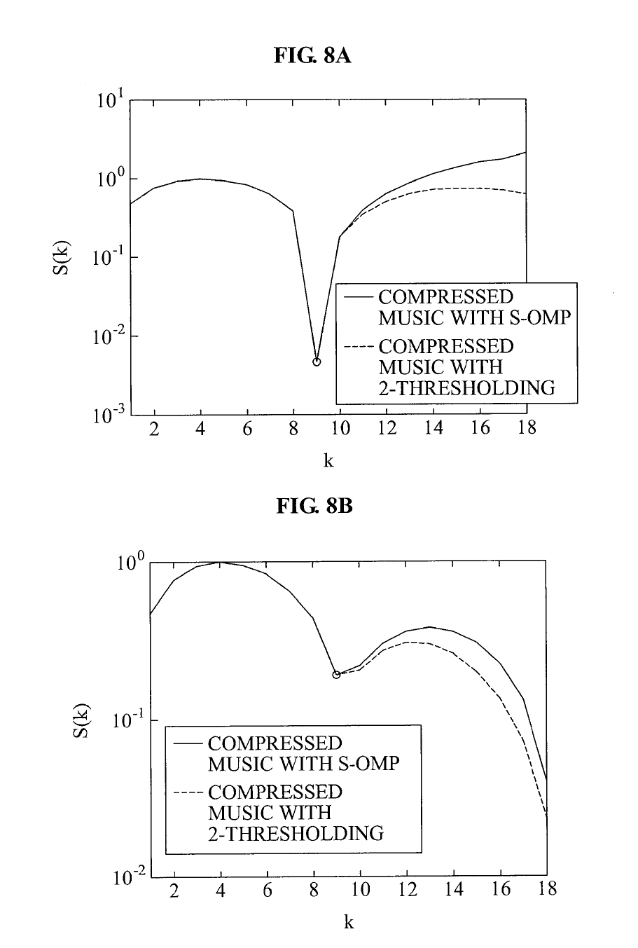

FIGS. 8A and 8B are graphs showing a cost function for a sparsity estimation operation according to an embodiment of the present invention.

Here, the number of measurements is 20, the true sparsity is 9, and the rank of the measurement matrix is 8.

The sparsity estimate corresponding to the first local minimizer is equal to the true sparsity level for both the noiseless case shown in FIG. 8A and a case with noise shown in FIG. 8B. In the graph 820, SNR=30 dB.

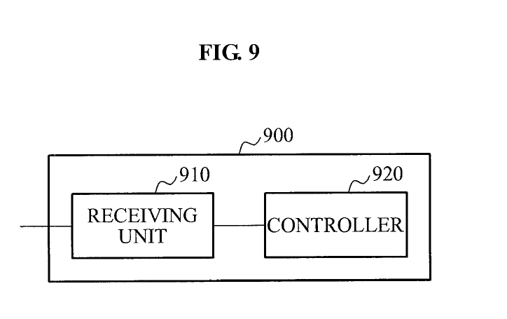

FIG. 9 is a block diagram illustrating a structure of an apparatus 300 for processing a plurality of measurements or snapshots of jointly sparse signals according to an embodiment of the present invention.

Referring to FIG. 9, the apparatus 900 may include a receiving unit 910 and a controller 920.

The apparatus 900 may reconstruct jointly sparse signals from the plurality of snapshots.

The receiving unit 910 may receive information required to process the plurality of measurements. For example, the receiving unit 910 may receive the snapshots.

The controller 920 may perform an operation for processing the plurality of measurements, for example, operations 410 through 430 of FIG. 4.

For example, the controller 920 may generate a first subset of an estimate of the joint support of a solution matrix according to a CS-MMV scheme selected using the plurality of snapshots, and may generate a second subset of an estimate of the joint support according to a subspace-based scheme using the plurality of snapshots and the first subset.

The controller 920 may estimate the number of targets. The total number of the elements in the first subset and the in the second subset may correspond to the number of targets.

The controller 920 may generate the second supports based on a rank of a matrix generated using the plurality of snapshots, the first supports, and a basis vector of a dictionary excluded from the first supports.

Descriptions made above with reference to FIG. 1 through FIG. 8 may be applicable to the present embodiment and thus, further detailed descriptions will be omitted here.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as application specific integrated circuits (ASICs), field-programmable gate arrays (FPGAs), read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa. Computer-readable media may also be computer code transmitted by a computer data signal embodied in a carrier wave and representing a sequence of instructions that are executable by a processor.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of extracting information from a plurality of measurement vectors of jointly sparse signals, the method comprising:
extracting signal subspace information from the plurality of measurement vectors of the jointly sparse signals;
computing a subset with at least one element of a joint support based on the plurality of measurement vectors; and
computing at least one additional element of the joint support based on the signal subspace information and the subset.

2. The method of claim 1, wherein the plurality of measurement vectors are obtained from at least one sensor.

3. The method of claim 1, wherein the signal subspace information comprises at least one of a dimension of a signal subspace, a basis for spanning the signal subspace, a projection onto the signal subspace, a basis for the orthogonal complement of the signal subspace, and a projection onto the orthogonal complement of the signal subspace.

4. The method of claim 1, wherein the extracting of the signal subspace information is performed by a singular value decomposition (SVD) or a principal component analysis (PCA).

5. The method of claim 1, wherein the extracting of the signal subspace information is performed by a robust PCA.

6. The method of claim 1, wherein the computing of the subset uses the signal subspace information.

7. The method of claim 1, wherein the computing of the subset comprises partially executing a greedy algorithm for support recovery.

8. The method of claim 1, wherein the computing of the subset comprises obtaining a subset of the joint support according to a support recovery scheme.

9. The method of claim 1, wherein the computing of the subset is performed by singular value thresholding a measure of magnitudes of signal estimates obtained according to a jointly sparse signal recovery scheme.

10. The method of claim 1, wherein the computing of the subset is repeated to generate a plurality of candidate subsets of the joint support.

11. The method of claim 3, wherein the computing of the at least one additional element uses an augmented signal subspace formed by augmentation of a signal subspace estimate by the subspace spanned by the columns of a sensing matrix that are indexed by the subset of the joint support.

12. The method of claim 11, wherein the computing of the at least one additional element comprises finding, from the columns of the sensing matrix whose indices are absent from the subset of the joint support, at least one column whose orthogonal projection onto the augmented signal subspace has the largest Euclidean norm.

13. The method of claim 11, wherein the computing of the at least one additional element comprises finding, from the columns of the sensing matrix whose indices are absent from the subset of the joint support, at least one column whose orthogonal projection onto the orthogonal complement of the augmented signal subspace has the smallest Euclidean norm.

14. The method of claim 1, further comprising:
estimating a sparsity level of a jointly sparse signal according to a greedy support recovery algorithm.

15. A method of processing a plurality of snapshots, the method comprising:
receiving the plurality of snapshots;
generating first subset of an estimate of the support of a signal matrix according to a compressed sensing-multiple measurement vector (CS-MMV) scheme using the plurality of snapshots; and
generating second subset of an estimate of the support of a signal matrix according to a subspace based scheme using the plurality of snapshots and the first subset.

16. The method of claim 15, further comprising:
estimating a number of targets,
wherein the total number of elements in the first subset and in the second subset corresponds to the number of targets.

17. The method of claim 15, wherein the generating of the second subset comprises using the rank of a matrix generated from the plurality of snapshots, and from a basis vector of a dictionary wherein the index of the basis vector is excluded from the first subset.

18. An apparatus for the recovery of a joint support of jointly sparse signals from a plurality of snapshots, the apparatus comprising:
a receiving unit to receive the plurality of snapshots; and
a controller to generate first subset of an estimate of the joint support according to a compressed sensing-multiple measurement vector (CS-MMV) scheme using the plurality of snapshots, and to generate second subset of an estimate of the join support according to a subspace based scheme using the plurality of snapshots and the first subset.

19. The apparatus of claim 18, wherein:
the controller estimates a number of targets, and
the total number of elements in the first subset and in the second subset corresponds to the number of targets.

20. The apparatus of claim 18, wherein the controller generates the second subset based on the rank of a matrix generated using the plurality of snapshots, the first subset, and a basis vector of a dictionary wherein the index of the basis vector is excluded from the first subset.

21. A method of processing a plurality of snapshots of jointly sparse signals, the method comprising:
receiving the plurality of snapshots;
generating first matrix comprising the plurality of snapshots;
generating first subset of an estimate of the joint support of the jointly sparse signals according to a compressed sensing-multiple measurement vector (CS-MMV) scheme, the CS-MMV scheme using the first matrix, wherein the cardinality of the first subset is determined based on the difference between the estimated number of targets and the rank of the first matrix; and
generating second subset of an estimate of the support of the jointly sparse signals based on the first matrix and the first subset.

22. The method of claim 21, further comprising:
generating an an estimate of a sparsity level based on a cost function,
wherein an output value of the cost function corresponds to the minimum value of an initial region of input values within a predetermined range.
